(19) United States
(12) Patent Application Publication
(10) Pub. No.: US 2007/0228023 A1
(43) Pub. Date: Oct. 4, 2007

(54) Pulsed Synchronized Laser Cutting of Stents

(76) Inventors: Klaus Kleine, Los Gatos, CA (US); William Jason Fox, San Carlos, CA (US); Scott Palley, Fremont, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/278,131

(22) Filed: Mar. 30, 2006

(51) Int. Cl. B23K 26/38

(52) U.S. Cl. 219/121.67; 219/121.61; 700/166; 219/121.72

(57) ABSTRACT

A system for pulsed synchronized laser cutting of stents and/or other medical products includes a numerical controller and a machine for moving a tube of material during cutting. A pulsed fiber laser is configured to cut the tube into, for example, a stent, the numerical controller being in communication with the machine and configured to send movement control information to the machine. The numerical controller may also receive movement speed information from the machine. The numerical controller is also in communication with the pulsed fiber laser and is configured to send pulse control information to the pulsed fiber laser. The numerical controller is configured to cause average laser power to decrease by decreasing frequency of laser pulses as stent cutting speed decreases, and to cause average laser power to increase by increasing frequency of laser pulses as stent cutting speed increases.

### BACKGROUND OF THE INVENTION

This invention relates generally to improvements in the manufacture of expandable metal stents and, more particularly, to new and improved efficient methods and apparatus for direct laser cutting of metal stents.

Stents are expandable endoprosthesis devices which are adapted to be implanted into a patients body lumen, such as a blood vessel, to maintain the patency of the vessel. These devices are typically used in the treatment of atherosclerotic stenosis in blood vessels and the like.

In the medical arts, stents are generally tubular-shaped devices which function to hold open a segment of a blood vessel or other anatomical lumen. They are particularly suitable for use to support and hold back a dissected arterial lining which can occlude the fluid passageway.

Various means have been provided to deliver and implant stents. One method frequently described for delivering a stent to a desired intraluminal location includes mounting the expandable stent on an expandable member, such as a balloon, provided on the distal end of an intravascular catheter, advancing the catheter to the desired location within the patient's body lumen, inflating the balloon on the catheter to expand the stent into a permanent expanded condition and then deflating the balloon and removing the catheter.

One example of a particularly useful expandable stent is a stent which is relatively flexible along its longitudinal axis to facilitate delivery through tortuous body lumens, but which is stiff and stable enough radially in an expanded condition to maintain the patency of a body lumen such as an artery when implanted within the lumen. Such a desirable stent typically includes a plurality of radially expandable cylindrical elements which are relatively independent in their ability to expand and to flex relative to one another. The individual radially expandable cylindrical elements of the stent are precisely dimensioned so as to be longitudinally shorter than their own diameters. Interconnecting elements or struts extending between adjacent cylindrical elements provide increased stability and are positioned to prevent warping of the stent when it is expanded. The resulting stent structure is a series of radially expandable cylindrical elements which are spaced longitudinally close enough so that small dissections in the wall of a body lumen may be pressed back into position against the luminal wall, but not so close as to compromise the longitudinal flexibility of the stent. The individual cylindrical elements may rotate slightly relative to adjacent cylindrical elements without significant deformation, cumulatively giving a stent which is flexible along its length and about its longitudinal axis, but is still very stiff in the radial direction in order to resist collapse.

The prior art stents generally have a precisely laid out circumferential undulating pattern. The transverse cross-section of the undulating component of the cylindrical element is relatively small and preferably has an aspect ratio of about two to one to about one-half-to-one. A one-to-one aspect ratio also has been found particularly suitable. The open reticulated structure of the stent allows for the perfusion of blood over a large portion of the arterial wall which can improve the healing and repair of a damaged arterial lining.

The radial expansion of the expandable cylinder deforms the undulating pattern similar to changes in a waveform which result from decreasing the waveform's amplitude and the frequency. In the case of a balloon-expandable stent, such as one made from stainless steel, the cylindrical structures of the stent are plastically deformed when expanded so that the stent will remain in the expanded condition and, therefore, they must be sufficiently rigid when expanded to prevent their collapse in use. During expansion of the stent, portions of the undulating pattern may tip outwardly resulting in projecting members on the outer surface of the expanded stent. These projecting members tip radially outwardly from the outer surface of the stent and embed in the vessel wall and help secure the expanded stent so that it does not move once it is implanted.

The elements or struts which interconnect adjacent cylindrical elements should have a precisely defined transverse cross-section similar to the transverse dimensions of the undulating components of the expandable cylindrical elements. The interconnecting elements may be formed as a unitary structure with the expandable cylindrical elements from the same intermediate product, such as a tubular element, or they may be formed independently and connected by suitable means, such as by welding or by mechanically securing the ends of the interconnecting elements to the ends of the expandable cylindrical elements. Preferably, all of the interconnecting elements of a stent are joined at either the peaks or the valleys of the undulating structure of the cylindrical elements which form the stent. In this manner, there is minimal or no shortening of the stent upon expansion.

The number and location of elements interconnecting adjacent cylindrical elements can be varied in order to develop the desired longitudinal flexibility in the stent structure both in the unexpanded, as well as the expanded condition. These properties are important to minimize alteration of the natural physiology of the body lumen into which the stent is implanted and to maintain the compliance of the body lumen which is internally supported by the stent. Generally, the greater the longitudinal flexibility of the stent, the easier and the more safely it can be delivered to the implantation site.

It will be apparent from the foregoing that conventional stents are very high precision, relatively fragile devices and, ideally, the most desirable metal stunts incorporate a fine precision structure cut from a very small diameter, thin-walled cylindrical tube. In this regard, it is extremely important to make precisely dimensioned, smooth, narrow cuts in the stainless tubes in extremely fine geometries without damaging the narrow struts that make up the stent structure.

It is also important to prevent overheating of the complex stent structure during the manufacturing process, so that the material is not damaged. A stent pattern typically includes tight bends and turns. The system that moves the stunt material during cutting generally accelerates and decelerates in these bends and turns as the stent is cut. As a result, cutting systems in which the laser runs at constant pulse frequencies tend to put more laser power in the tight bends and turns. Those areas can become heat affected zones (HAZ), and care must be taken to ensure that the laser power is set sufficiently low so that the heat in the HAZ does not cause damage to the stent material. One such approach is described in U.S. patent application Ser. No. 10/946,223, entitled, “Pulsed Fiber Laser Cutting System For Medical Implants,” published as Publication Number US 2005/0035101 and which is incorporated by reference herein. Similarly, U.S. Pat. No. 6,521,865, issued on Feb. 18, 2003 and entitled, “Pulsed Fiber Laser Cutting System for Medical Implants,” is also incorporated by reference herein.

While the various laser cutting processes heretofore utilized by the prior art to form such expandable metal stents have been adequate, improvements have been sought to manufacture stents in a more efficient manner and with less heat build-up at critical locations on the stent during the stent cutting operation. The present invention satisfies these and other needs.

### SUMMARY OF THE INVENTION

Briefly, and in general terms, the present invention provides a new and improved method and apparatus for direct laser cutting of metal and/or polymeric stents with pulsed lasers.

The present invention provides an improved system for producing metal stents with a fine precision structure cut from a small diameter, thin-walled, cylindrical tube. The tubes are typically made of stainless steel or polymeric material and are fixtured under a laser and positioned utilizing CNC (computer numerical control) to generate a very intricate and precise pattern. Due to the thin-wall and the small geometry of the stent pattern, it is necessary to have very precise control of the laser, its power level, and the precise positioning of the laser cutting path.

In one embodiment of the invention, in order to minimize the heat build-up, which prevents thermal distortion, uncontrolled burnout of the stent material, and damage due to excessive heat, a diode pumped fiber laser is utilized. The laser is “pulsed,” in that a pulse generator causes the laser to operate in pulses. Broadly speaking, the laser pulsing is synchronized with the cutting speed. The average laser power is thereby reduced in the slower cutting areas. Consequently, heat build up in the slower cutting areas is also reduced. It is thereby possible to make smooth, narrow cuts in the stainless steel tubes in very fine geometries without damaging the narrow struts that make up the stent structure and, in some embodiments, to speed up the rate at which the stent is cut.

In one embodiment, the system includes a numerical controller and a machine for moving a tube of material radially and linearly. A pulsed fiber laser is configured to cut the tube into a stent, the numerical controller being in communication with the machine and configured to send movement control information to the machine. The numerical controller may also receive movement speed information from the machine.

In this embodiment, the numerical controller is also in communication with the pulsed fiber laser and is configured to send pulse control information to the pulsed fiber laser. The numerical controller is configured to cause average laser power to decrease by decreasing frequency of laser pulses as stent cutting speed decreases, and to cause average laser power to increase by increasing frequency of laser pulses as stent cutting speed increases.

Embodiments of the system may also include various other features. The machine may comprise a linear slide and/or a rotary motor that is controlled by the numerical controller. A computer may be provided for programming the numerical controller. The pulse control information may comprise a series of rectangular waves at a frequency that varies in conjunction with the cutting speed.

In accordance with another aspect of the invention, a system for cutting a stent with a laser includes a numerical controller, a machine for moving a tube of material, and a laser configured to cut a stent from the tube of material. The numerical controller is in communication with the machine and is configured to control stent cutting speed. The numerical controller is also in communication with the laser and is configured to send average power control information to the laser. The average power control information is synchronized with the stent cutting speed.

Embodiments of the present invention may also extend to a method of forming a stent. A stent may be cut with a laser-cutting apparatus. At least one portion of the stent may be cut at a first speed, and at least a portion of the stent may be cut at a second slower speed. The system then pulses the laser at a first pulse frequency while the stent is cut at the first speed, and pulses the laser at a second pulse frequency while the stent is cut at the second speed. The laser outputs a lower average laser power at the second pulse frequency than at the first pulse frequency.

According to one embodiment of the invention, the laser is collimated to a diameter of approximately 1 to 10 mm. The laser is then focused to approximately 0.5 to 2 mil on the surface of a tube of stent material. The method may also include inserting a mandrel into the tube of stent material. Further steps may include moving a tube of stent material in axial and rotary directions during cutting, and synchronizing the pulse output signal to the laser with the cutting speed in at least one of the axial and rotary directions.

In one embodiment in which a pulsed laser is used, the average laser power is a function of at least one of the pulse width, the pulse height, and the pulse frequency. Using a pulsed laser, one or more of these variables may be altered in order to vary the average laser power.

Hence, the new and improved method and apparatus for direct laser cutting of metal stents, in accordance with the present invention, makes accurate, reliable, high resolution, expandable stents with patterns having smooth, narrow cuts and very fine geometries, with minimal heat build-up during the stent-cutting process.

The above and other objects and advantages of this invention will be apparent from the following more detailed description when taken in conjunction with the accompanying drawings of exemplary embodiments.

### BRIEF DESCRIPTION OF THE DRAWINGS

The invention is herein described, by way of example only, with reference to the accompanying drawings, wherein:

FIG. 1 is an elevational view, partially in section, of a stent embodying features of the invention which is mounted on a delivery catheter and disposed within an artery.

FIG. 2 is an elevational view, partially in section, similar to that shown in FIG. 1, wherein the stent is expanded within an artery.

FIG. 3 is an elevational view, partially in section, showing the expanded stent within the artery after withdrawal of the delivery catheter.

FIG. 4 is a perspective view of a stent embodiment in an unexpanded state, with one end of the stent being shown in an exploded view to illustrate the details thereof.

FIG. 5 is a plan view of a flattened section of a stent of the invention which illustrates the undulating pattern of the stent as shown in FIG. 4.

FIG. 5a is a sectional view taken along the line 5a-5a in FIG. 5.

FIG. 6 is a schematic representation of equipment for cutting a stent, in accordance with the present invention.

FIG. 7A is a graph indicating a cutting speed that decreases and then increases.

FIG. 7B is a graph illustrating how pulses from the CNC vary as the cutting speed varies.

FIG. 7C is a graph illustrating how the laser pulses vary as the cutting speed varies.

### DETAILED DESCRIPTION OF THE PREFERRED EMBODIMENTS

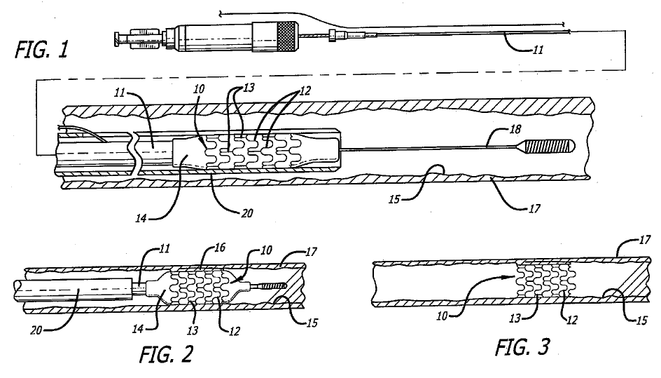

Referring now to the drawings, and particularly to FIG. 1, there is shown a stent 10 that is mounted onto a delivery catheter 11. The stent 10 is simply an example of one of a great many different stent designs and other medical devices that can be cut using the technique and apparatus of the present invention. Generally, a stent is a high precision patterned tubular device. A stent typically comprises a plurality of radially expanded cylindrical elements 12 disposed generally coaxially and interconnected by elements 13 disposed between adjacent cylindrical elements. The delivery catheter has an expandable portion or balloon 14 for expanding of the stent within an artery 15. Alternatively, the stent may be self-expanding, for example.

The typical delivery catheter 11 onto which the stent 10 is mounted is essentially the same as a conventional balloon dilatation catheter for angioplasty procedures. The balloon 14 may be formed of suitable materials such as polyethylene, polyethylene terephthalate, polyvinyl chloride, nylon and ionomers such as Surlyn® manufactured by the Polymer Products Division of the Du Pont Company. Other polymers may also be used. In order for the stent to remain in place on the balloon during delivery to the site of the damage within the artery 15, the stent is compressed onto the balloon. A retractable protective delivery sheath 20 may be provided to further ensure that the stent stays in place on the expandable portion of the delivery catheter and prevent abrasion of the body lumen by the open surface of the stent during delivery to the desired arterial location. Other means for securing the stent onto the balloon may also be used, such as providing collars or ridges on the ends of the working portion, i.e., the cylindrical portion, of the balloon.

The delivery of the stent 10 is accomplished, for example, in the following manner. The stent is first mounted onto the inflatable balloon 14 on the distal extremity of the delivery catheter 11. The balloon is slightly inflated to secure the stent onto the exterior of the balloon. The catheter-stent assembly is introduced within the patient's vasculature in a conventional Seldinger technique through a guiding catheter (not shown). A guide wire 18 is disposed across the target arterial section and then the catheter/stent assembly is advanced over the guide wire within the artery 15 until the stent is positioned in the target area. The balloon of the catheter is expanded, expanding the stent against the artery, which is illustrated in FIG. 2. While not shown in the drawing, the artery is preferably expanded slightly by the expansion of the stent to seat or otherwise fix the stent to prevent movement. In some circumstances during the treatment of stenotic portions of an artery, the artery may have to be expanded considerably in order to facilitate passage of blood or other fluid therethrough.

The stent 10 serves to hold open the artery 15 after the catheter 11 is withdrawn, as illustrated by FIG. 3. Due to the formation of the stent from an elongated tubular member, the undulating component of the cylindrical elements of the stent is relatively flat in transverse cross-section, so that when the stent is expanded, the cylindrical elements are pressed into the wall of the artery and, as a result, do not interfere with the blood flow through the artery. The cylindrical elements 12 of the stent, which are pressed into the wall of the artery, will eventually be covered with endothelial cell growth which farther minimizes blood flow interference. The undulating portion of the cylindrical elements provides good tacking characteristics to prevent stent movement within the artery. Furthermore, the closely spaced cylindrical elements at regular intervals provide uniform support for the wall of the artery and, consequently, are well adapted to tack up and hold in place small flaps or dissections in the wall of the artery.

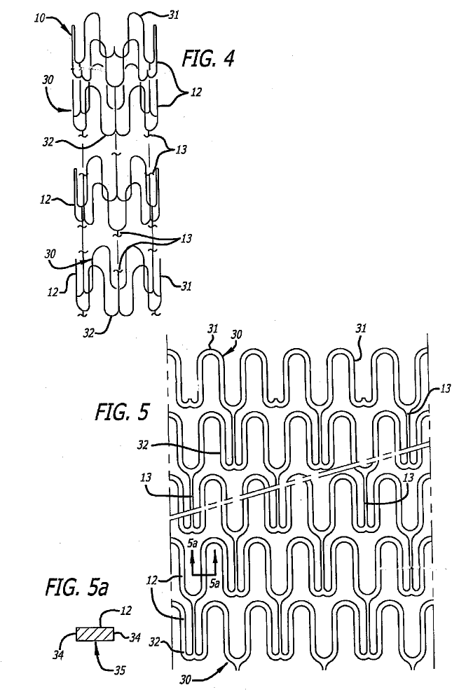

FIG. 4 is an enlarged perspective view of the stent 10 shown in FIG. 1 with one end of the stent shown in an exploded view to illustrate in greater detail the placement of interconnecting elements 13 between adjacent radially expandable cylindrical elements 12. Each pair of interconnecting elements on one side of a cylindrical element are preferably placed to allow maximum flexibility for a stent. In the embodiment shown in FIG. 4, the stent has three interconnecting elements between adjacent radially expandable cylindrical elements that are 120 degrees apart. Each pair of interconnecting elements on one side of a cylindrical element are offset radially 60 degrees from the pair on the other side of the cylindrical element. The alternation of the interconnecting elements results in a stent which is longitudinally flexible in essentially all directions. The primary flexibility of this stent design derives from the cylindrical elements, while the interconnecting element actually reduces the overall stent flexibility. Various configurations for the placement of interconnecting elements are possible.

The number of undulations may also be varied to accommodate placement of interconnecting elements 13, e.g., at the peaks of the undulations or along the sides of the undulations as shown in FIG. 5.

As best observed in FIGS. 4 and 5, the cylindrical elements 12 are in the form of an undulating pattern 30. As previously mentioned, each cylindrical element is connected by interconnecting elements 13. The undulating pattern is made up of a plurality of U-shaped members 31 and W-shaped members 32, each having a different radius so that expansion forces are more evenly distributed over the various members.

The aforedescribed illustrative stent 10 and similar stent structures can be made in many ways. However, the preferred method of making the stent is to cut a thin-walled tubular member 16, such as stainless steel tubing, to remove portions of the tubing in the desired pattern for the stent, leaving relatively untouched the portions of the metallic tubing which are to form the stent.

The tubing 16 may be made of a suitable biocompatible material such as stainless steel or a suitable polymeric material known in the art. For example, stainless steel tubing may be Alloy type 316L SS, Special Chemistry per ASTM F138-92 or ASTM F139-92 grade 2. Special Chemistry of type 316L per ASTM F138-92 or ASTM F139-92 Stainless Steel for surgical implants in weight percent is as follows:

1 Carbon (C) 0.03% max. Manganese (Mn) 2.00% max. Phosphorous (P) 0.025% max. Sulphur (S) 0.010% max. Silicon (Si) 0.75% max. Chromium (Cr) 17.00-19.00% Nickel (Ni) 13.00-15.50% Molybdenum (Mo) 2.00-3.00% Nitrogen (N) 0.10% max. Copper (Cu) 0.50% max. Iron (Fe) Balance

Embodiments of the present pulsed fiber laser cutting system can be used to cut any stent pattern and virtually any stent material. The invention is not limited to cutting tubular members made from stainless steel. For example, tubular members formed from any number of metals are possible, including cobalt-chromium, titanium, nickel-titanium, tantalum, gold, platinum, nickel-titanium-platinum, and other similar metal alloys, or from a polymeric material known in the art for making stents.

The stent diameter is very small, so the tubing from which it is made must necessarily also have a small diameter. For coronary applications, typically, the stent has an outer diameter on the order of about 1.5 mm (0.06 inch) in the unexpanded condition, equivalent to the tubing from which the stent is made, and can be expanded to an outer diameter of 2.5 mm (0.100 inch) or more. The wall thickness of the tubing is about 0.08 mm (0.003 inch).

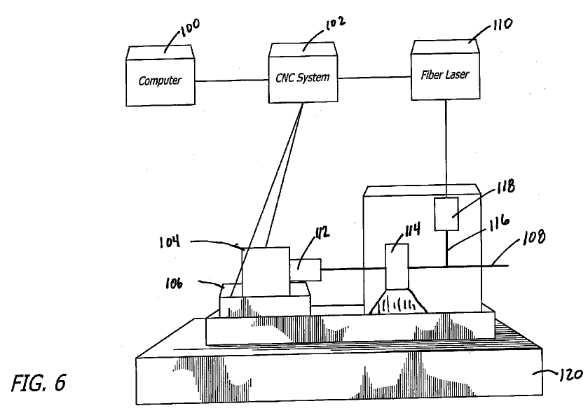

In accordance with the present invention, it is preferred to cut the tubing in the desired pattern by means of a machine-controlled laser as illustrated schematically in FIG. 6. As general background, a machine-controlled laser cutting system is disclosed in U.S. Pat. No. 5,780,807 to Richard J. Saunders and is incorporated herein by reference. The tubing is placed in a rotatable collet fixture of a machine-controlled apparatus for positioning the tubing relative to the laser. According to machine-encoded instructions, the tubing is rotated and moved longitudinally relative to the laser, which is also machine-controlled. The laser selectively removes the material from the tubing by ablation and a pattern is cut into the tube. The tube is therefore cut into the discrete pattern of the finished stent.

Referring in more detail to FIG. 6, as one example of a system in accordance with the present invention, a computer 100 is provided on which programming of the CNC system 102 can be performed. The operator can create a defined pulse overlap on the computer 100, define the stent pattern to cut, establish the relationship between the cutting speed and the pulse output, and/or otherwise program the CNC system 102. Generally, the term “cutting speed” is known in the art and relates to the speed of the vector moves performed by the linear and rotary cutting stages.

Because there are a great many different stent designs, with different intricate geometries, thicknesses and other variables, the desired pulse width for specific cutting speeds will be defined by the user. In most applications, pulse width will be determined during process development for a particular stent pattern. The pulse width, or “laser ON time,” is adjusted until the laser successfully pierces through the stent material at all points that need to be cut on the stent, while keeping the heat that builds up in the stent at a low level.

The CNC system 102 communicates with and controls the rotary motor 104 and the linear slide 106. The rotary motor 104 and the linear slide 106 may provide feedback to the CNC 102, such as information as to actual positioning and/or motion of the tubing 108. In this way, the CNC system has accurate positioning and/or motion information from which to calculate the pulse information that will be sent to the fiber laser 110, with which the CNC system 102 is in communication.

As non-limiting examples, a suitable linear slide and rotary motor are available from Aerotech, under model numbers ALS5000 (linear stage) and ASR1100 (rotary stage). However, other suitable linear slides and rotary motors are known in the art.

A collet 112 holds the tubing material 108. The tubing 108 is further supported by a bushing 114. A laser beam 116 is focused from a laser head 118 onto the tubing 108, to cut a stent as the tubing is moved. A granite base 120, for example, serves as a foundation for the motor 104, slide 106, collet 112 and bushing 114.

The process of cutting a pattern for the stent from the tubing 108 is automated except for loading and unloading the length of tubing. Referring again to FIG. 6, the cutting may be done, for example, using a collet fixture for axial rotation of the length of tubing, in conjunction with a linear slide for movement of the length of tubing axially relative to the machine-controlled laser, as described. The program for control of the apparatus is dependent on the particular configuration used and the pattern to be ablated in the tubing. As an alternative to the linear slide 106, a machine for moving the tubing 108 in both the X and Y directions may be used.

Considering the fiber laser 110, a diode pumped fiber laser typically is comprised of an optical fiber and a diode pump integrally mounted coaxial to the optical fiber. In one embodiment, two mirrors are mounted within the optical fiber such that the mirrors are parallel to one another and normal to the central axis of the optical fiber. The two mirrors are spaced apart by a fixed distance creating an area within the optical fiber between the mirrors called the active region. As one non-limiting example, one suitable fiber laser is available from SPI Lasers, plc of Southampton, UK, under model number SPI-100C-0013-100PT-P00247, although a variety of fiber lasers known in the art may be used in conjunction with the present invention.

Optionally, the diode pumped fiber laser may incorporate a coaxial gas jet and nozzle that helps to remove debris from the kerf and cools the region where the beam interacts with the material as the beam cuts and vaporizes the metal. In other embodiments of the present invention, compressed air may be used in the gas jet since it offers more control of the material removed and reduces the thermal effects of the material itself. Inert gas such as argon, helium, or nitrogen can be used to eliminate any oxidation of the cut material. The result is a cut edge with no oxidation, but there is usually a tail of molten material that collects along the exit side of the gas jet that must be mechanically or chemically removed after the cutting operation.

It is desirable in some applications to block the laser beam as it cuts through the top surface of the tube and prevent the beam, along with the molten metal and debris from the cut, from impinging on the inside opposite surface of the tube 108. To this end, a stainless steel mandrel (approx. 0.864 mm diameter (0.034 inch) in one embodiment) may be placed inside the tube and allowed to roll on the bottom of the tube 108 as the pattern is cut. This acts as a beam/debris block protecting the far wall inner diameter.

It is an aspect of the present invention to optimize the laser system for the particular speed at which the system is cutting at a given time, in order to minimize heat build-up. To accomplish this, the laser pulsing is synchronized with the stent cutting speed. As mentioned previously, a stent pattern often includes complex tight bends and turns. The system that moves the stent material during cutting must likewise follow those bends and turns with very high accuracy. To stay on the cutting path, the motion system decelerates and accelerates as it traverses the pattern of the stent. As discussed previously, current stent laser cutting systems typically run at constant pulse frequencies. Consequently, in the regions in which the cutting system slows down, such as in the tight bends and turns of the stent, more laser power is applied over time than in the straighter portions of the stent pattern.

The stent can become overheated in those tight bend and turn areas, causing a heat affected zone (HAZ). If the heat is excessive, the stent material may be adversely affected. In the case of certain metals, for example, the material may be hardened or softened as a result of the excess heat. So, according to the present invention, the laser is automatically adjusted during the cutting process to have a relatively low average power when the cutting speed slows down, so as not to overheat the material in certain areas.

In particular, an improvement according to the present invention relates to synchronizing the laser pulse with the cutting speed, in order to lower the average laser power in the slower cutting areas, but maintaining a higher average laser power in the faster cutting areas. In one embodiment of the approach, a relatively uniform minimum HAZ throughout the stent during the stent cutting process is achieved. The overall time required to cut a stent is reduced, and cutting performance is thereby enhanced.

Considering one embodiment of a method of stent manufacture, the laser is collimated to a beam diameter of approximately 1 to 10 mm. The laser is focused to a 0.5 to 2 mil wide beam on the material surface. The stent material is in tubular form and is supported by a collet. A mandrel is inserted into the tubing to protect the opposite tubing wall from the laser beam. The stent pattern is then cut into the material by moving the tube in axial and rotary directions with respect to the laser-cutting beam. The axial and rotary motion is controlled by the CNC system. One suitable motion control system is the Aerotech Automation 3200, although others are known in the art. One embodiment of a suitable Aerotech 3200 motion system includes an Aerotech Npaq or NDrive servo amplifier. A standard industrial computer of the type known in the art runs the software that drives the control system.

The speed at which the stent is cut is synchronized with a pulse output signal from the CNC system. This is accomplished by providing the output signal to the gate input of the laser. The laser then provides laser pulses according to the gate signal. As a result, the average laser power is reduced in areas of the stent where the cutting is slower, and is relatively greater in areas of the stent where the cutting is faster.

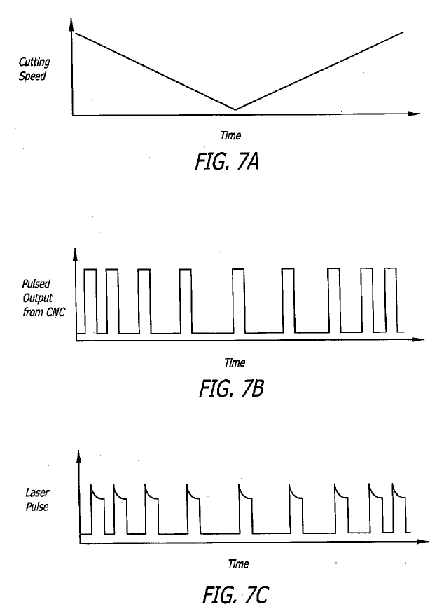

FIGS. 7A-C illustrate in general terms a relationship between the stent cutting speed, the pulsed output from the CNC unit, and the laser pulse. In FIG. 7A, the cutting speed at a particular location on the stent drops to a minimum, then increases again. In FIG. 7B, the corresponding pulsed output from the CNC shows that the time in between pulses increases as the cutting speed decreases, and vice-versa. Accordingly, in FIG. 7C, the laser responds to the pulse pattern from the CNC by increasing the time in between laser pulses as the cutting speed decreases. In this way, the average laser power over time that is directed at the stent material, decreases when the cutting slows down. Likewise, when the cutting speed again increases, the time in between laser pulses decreases, thereby increasing the average laser power over time that is directed at the stent material.

FIGS. 7A-C illustrate just one example of how laser power can be controlled. More generally, laser power can be controlled in a variety of ways, such as by adjusting one or more of pulse width, pulse height, and pulse frequency.

It will be apparent from the foregoing that the present invention provides a new and improved method and apparatus for direct laser cutting of metal stents, enabling greater precision, reliability, manufacturing efficiency, structural integrity and/or overall quality. While the invention has been illustrated and described herein in terms of its use relative to an intravascular stent for use in arteries and veins, it will be apparent to those skilled in the art that the invention can be used to manufacture stents for other uses, such as the biliary tract, or to expand prostatic urethras in cases of prostate hyperplasia, and to manufacture other medical products requiring precision micro-machining, such as for example embolic filters, implants, and a variety of other devices.

It is also noted that typically a single numerical controller controls both the linear and rotational speed of the cutting device, as well as the average laser power. However, the term “numerical controller” as used in the claims may encompass more than one numerical controller, when more than one numerical controller is used in a particular embodiment.

Therefore, while particular forms of the invention have been illustrated and described, various modifications can be made without departing from the spirit and scope of the invention. Accordingly, it is not intended that the invention be limited, except as by the appended claims

We claim:

1. A system for cutting a stent with a laser, comprising:
a numerical controller;
a machine for moving a tube of material;
a laser configured to cut a stent from the tube of material;
the numerical controller being in communication with the machine and configured to control stent cutting speed;
the numerical controller also being in communication with the laser and configured to send average power control information to the laser;
wherein the average power control information is synchronized with the stent cutting speed.

2. A system as defined in claim 1, wherein the numerical controller is configured to cause average laser power to decrease as stent cutting speed decreases and to cause average laser power to increase as stent cutting speed increases.

3. A system as defined in claim 1, wherein the machine moves the tube of material radially and linearly.

4. A system as defined in claim 3, wherein the machine comprises a linear slide and a rotary motor, both controlled by the numerical controller.

5. A system as defined in claim 1, wherein the controller is configured to receive movement speed information from the machine.

6. A system as defined in claim 1, wherein the system includes a computer for programming the numerical controller.

7. A system as defined in claim 1, wherein the laser is a fiber laser.

8. A system as defined in claim 1, wherein the laser emits pulses, and average laser power corresponds to frequency of the laser pulses.

9. A system as defined in claim 1, wherein the numerical controller outputs a control signal to an input gate of the laser.

10. A method of forming a stent, the method comprising:
cutting a stent with a laser apparatus, there being at least one portion of the stent that is cut at a first speed, and at least a portion of the stent that is cut at a second slower speed;
operating the laser apparatus at a first average laser power while the stent is cut at the first speed; and
operating the laser apparatus at a second average laser power while the stent is cut at the second slower speed, with the second average laser power being less than the first average laser power.

11. A method as defined in claim 10 which further comprises:
moving the tube in axial and rotary directions during cutting; and
synchronizing the average power control information to the laser with the cutting speed in at least one of the linear and rotary directions.

12. A system for cutting a stent with a laser, comprising:
means for cutting a stent;
means for controlling stent cutting speed;
means responsive to the stent cutting speed for reducing average laser power as the stent cutting speed decreases, and for increasing the average laser power as the stent cutting speed increases.

13. A system for cutting a stent with a laser as defined in claim 12, wherein the means for controlling stent cutting speed and the means responsive to the stent cutting speed for reducing average laser power constitute a single numerical controller.

14. A system for cutting a stent with a laser, comprising:
a numerical controller;
a machine for moving a tube of material radially and linearly;
a pulsed fiber laser configured to cut the tube into a stent;
the numerical controller being in communication with the machine and configured to send movement control information to the machine and to receive movement speed information from the machine;
the numerical controller also being in communication with the pulsed fiber laser and configured to send pulse control information to the pulsed fiber laser;
wherein the numerical controller is configured to cause average laser power to decrease by decreasing frequency of laser pulses as stent cutting speed decreases, and to cause average laser power to increase by increasing frequency of laser pulses as stent cutting speed increases.

15. A system as defined in claim 14, wherein the machine comprises a linear slide controlled by the numerical controller.

16. A system as defined in claim 14, wherein the machine comprises a rotary motor controlled by the numerical controller.

17. A system as defined in claim 14, wherein the system includes a computer for programming the numerical controller.

18. A system as defined in claim 14, wherein the pulse control information comprises a series of rectangular waves at a frequency that varies in conjunction with the cutting speed.

19. A method of forming a stent utilizing an apparatus as defined in claim 14, the method comprising:
cutting a stent with an apparatus as defined in claim 14 having a laser, there being at least one portion of the stent that is cut at a first speed, and at least a portion of the stent that is cut at a second slower speed;
pulsing the laser at a first pulse frequency while the stent is cut at the first speed; and
pulsing the laser at a second pulse frequency while the stent is cut at the second speed, with the laser outputting a lower average laser power at the second pulse frequency than at the first pulse frequency.

20. A method as defined in claim 19, wherein the method further comprises:
collimating the laser to a diameter of approximately 1 to 10 mm; and
focusing the laser to approximately 0.5 to 2 mil on the surface of a tube of stent material.

21. A method as defined in claim 19, wherein the method further comprises inserting a mandrel into the tube of stent material.

22. A method as defined in claim 19, wherein the method further comprises:
moving a tube of stent material in axial and rotary directions during cutting; and
synchronizing the pulse output signal to the laser with the cutting speed in at least one of the axial and rotary directions.

23. A system as defined in claim 1, wherein the average laser power is a function of the pulse width.

24. A system as defined in claim 1, wherein the average laser power is a function of the pulse height.

25. A system as defined in claim 1, wherein the average laser power is a function of the pulse frequency.

26. A system as defined in claim 14, wherein the average laser power is a function of the pulse width.

27. A system as defined in claim 14, wherein the average laser power is a function of the pulse height.

28. A system as defined in claim 14, wherein the average laser power is a function of the pulse frequency.
